(19) United States
(12) Patent Application Publication
(10) Pub. No.: US 2002/0073416 A1
(43) Pub. Date: Jun. 13, 2002

(54) Remote control account authorization system

(75) Inventor: Carolyn Ramsey Catan, Pleasantville, NY (US)

Correspondence Address: Jack E. Haken, c/o U.S. PHILIPS CORPORATION, Intellectual Property Department, 580 White Plains Road, Tarrytown, NY, 10591, US

(73) Assignee: PHILIPS ELECTRONICS NORTH AMERICA CORPORATION

(21) Appl. No.: 09/734,808

(22) Filed: Dec. 12, 2000

(51) Int. Cl. H04N 7/16; G06F 17/60; G06F 3/00; H04N 5/445; G06F 13/00; H04N 7/173

(52) U.S. Cl. 725/6; 725/134; 725/1; 725/60; 705/44

(57) ABSTRACT

A method and device for placing orders over a network using bioauthentication account authorization for an account having different users and access levels.

A method and device for placing orders over a network using bioauthentication account authorization for an account having different users and access levels.

### BACKGROUND OF THE INVENTION

It is becoming increasingly common for people to place orders for items over home shopping networks and/or the Internet. The user typically pays for these items using a credit card or an electronic wallet (e-wallet). Authorization for the payment requires certain key information such as, in the case of a credit card, the name of the person on the credit card, the credit card number, the credit limit, the amount of the purchase and the expiration date.

If a person has a credit card account and would like to let another person such as his or her teenager order a product over such a medium, the adult must give the child this key information. The problem with releasing this key information is that if the credit card has a $10,000 dollar credit limit, this key information gives the teenager access to $10,000 when in fact the adult wishes to only authorize a $20 purchase.

Another alternative is for the parent to place the order him or herself or to use the old fashioned method of sending a check or money order.

U.S. Pat. No. 5,845,260 describes a system which sets up imaginary accounts for children with predefined spending limits. These accounts are set up in a server and when the child initiates a charge request the child must input a predetermined code number; or, there is a specially prepared remote control for the child. The problem with this system is it requires the child to remember passwords which the child can mistakenly disclose to another child in the house or it requires the use of a separate remote control that can be used by another child or visitor in the house.

### SUMMARY OF THE INVENTION

Accordingly it is an object of the invention to provide a method and device for providing multiple person access to a single credit card account. Each person is given different credit limits to the same account by the owner of the account. Each person is verified using bioauthentication.

It is another object of the invention to provide a method and device, which, based on authentication of the user, enables the owner of the account to easily delegate different monetary degrees of access to the owner's single account to different people and enables the entire family to access the account via a bioauthentication sensor. In this embodiment the account and bioauthentication information is stored at a server so that access to the server can be achieved at home, at school, in a hotel, or other remote location.

It is a further object of the invention to provide a remote control with fingerprint authentication (or other bioauthentication method) for ordering products on television, via mobile phone or on-line. The owner of a credit card account inputs the key information into a local storage device such as the remote control or a set-top-box and provides different degrees of access ability to the money available in the account to different people. Each person must verify himself via the fingerprint sensor. Upon verification the person has access to make purchases via the television, cell phone service or Internet up to the access amount delegated to the person by the owner of the account. The owner of the account, whether the account is stored on a server or locally, has the ability to easily change the degree of access of sub-credit limits of each person such as for a birthday or other special occasion or reward.

It is yet a further object of the invention to have a single “BUY” button and fingerprint sensor all-in-one located on a remote control or mouse such that by depressing it, automatically provides the authentication information from the fingerprint sensor to a server or local storage device for authentication and charge request initiation.

Other objects and advantages will be apparent from the following disclosure and the scope of the invention will be indicated in the claims.

### BRIEF DESCRIPTION OF THE DRAWINGS

FIG. 1 shows a network in accordance with one preferred embodiment of the instant invention;

FIG. 2, shows a flow chart of how an initial account is set up in accordance with a preferred embodiment of the instant invention;

FIG. 3 shows a flow chart of how the account in FIG. 2 is accessed by an authorized user;

FIG. 4 shows a television ordering system in accordance with the preferred embodiment of the instant invention, and FIG. 5 shows a television ordering system which includes a “BUY” button with a fingerprint sensor.

### DESCRIPTION OF THE PREFERRED EMBODIMENTS

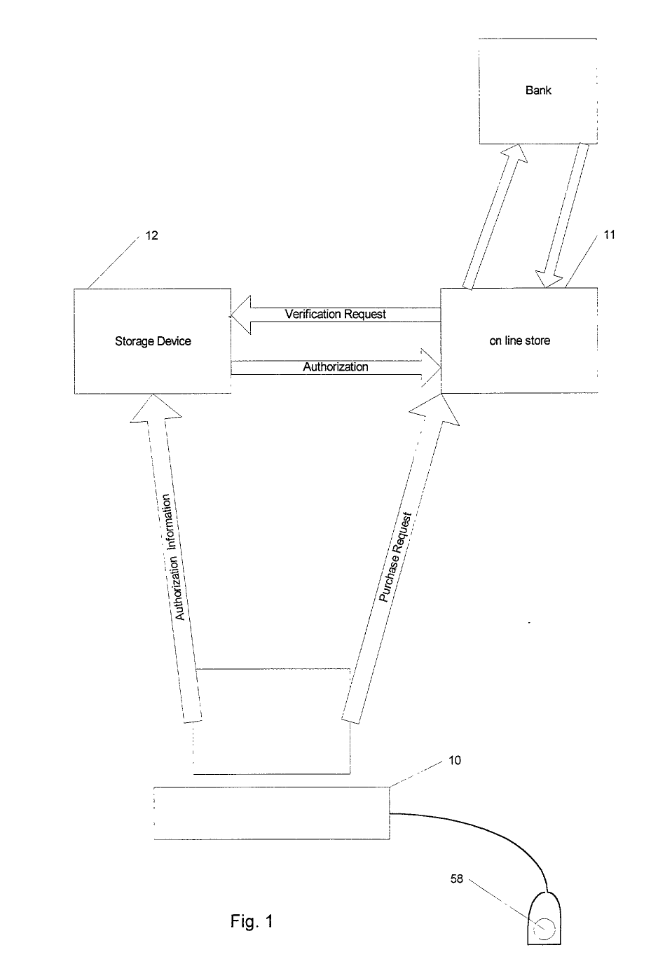

FIG. 1 shows an ordering network in accordance with a preferred embodiment of the invention. A home television, set-top-box (STB), PC 10 or other device is used to access the Internet or other network for on-line purchases. A single credit card account or debit account is set up, typically by a bank, for the credit card holder. The single credit card account is owned by the credit card holder; it has a single total credit limit and the credit card holder is responsible for all payments made from the account. The credit card holder also has several children or employees and would like to give access to this account to his employees and children but not enough access that each can spend the full amount of the credit limit.

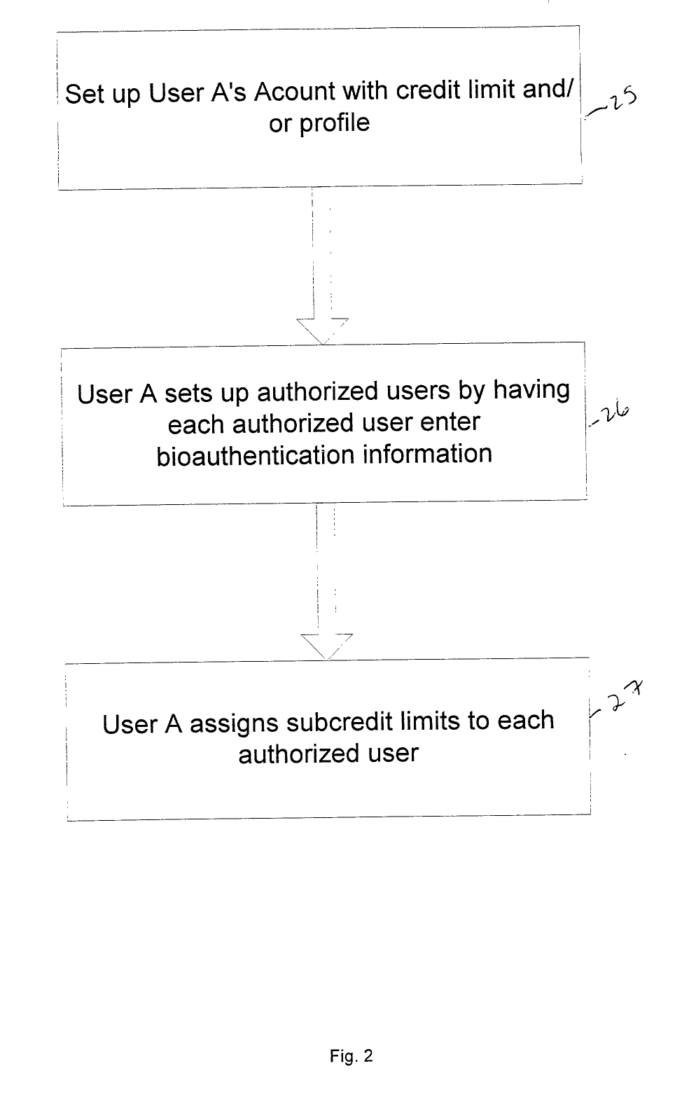

The credit card holder divides up authorization to the account as shown in FIG. 2. The bank, according to the credit card holder's credit rating, gives the credit card holder an authorized amount of credit 25. The credit card holder also tells the bank who the authorized users of the account 26 are. The authorized users each provide the bank with bioauthentication information which is unique to each authorized user 26, e.g. a fingerprint. The credit card holder also sets up a sub-credit limit for each authorized user 27. This sub-credit limit is less than or equal to the credit card holder's credit limit. The sub-credit limits can be based on amounts that each authorized user can spend per week, month or year or each access time. In this embodiment the bioauthentication information and account information are stored on a server which can be accessed remotely. The owner of the account also gives the bank his/her bioauthentication information so that the owner can access the account and also so that the owner can easily change the sub-credit limits of the authorized users.

An authorized user then uses his PC, mobile phone or television 10 to access the Internet and an on-line store 11. The authorized user selects an item or service for purchase. The on-line store 11 requests a credit card number. The bioauthentication information (fingerprint, iris scan etc.) is sent to the server 12. The server 12 locates the correct credit card information and checks whether the authorized user can spend the amount requested. In one embodiment, the authorized user informs the server 12 of the amount to be spent and in another embodiment the on-line store 11 gives the amount to the server. If authorization is approved, the server 12 sends the on-line store 11 the credit card information required to complete the sale.

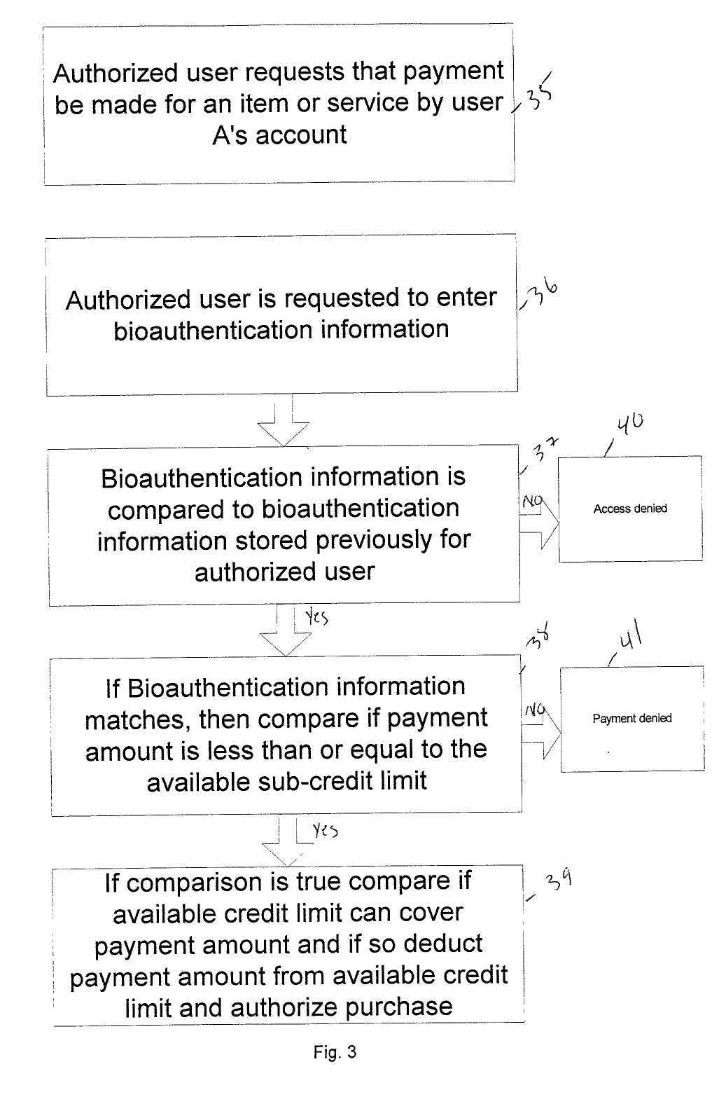

FIG. 3 shows a flow chart of the authentication procedure. The server 12 receives the request for payment under the credit card holder's account 35 from the authorized user. The server 12 requests that the authorized user enter authentication information 36. The authentication information is provided using a fingerprint sensor located on a remote control or mouse etc. The verifier 12 receives the authentication information and compares it 37 to the previously stored authentication information for the particular authorized user. If the authentication information does not match, then access is denied 40 to the credit card holder's account. If the authentication information matches then the payment amount is compared 38 to the authorized user's sub-credit limit. If the payment amount is less than or equal to the sub-credit limit amount then the payment amount is deducted from the credit card holder's available credit limit and the purchase is authorized 39. If the payment amount exceeds the authorized user's sub-credit limit amount then payment is denied 41. Depending on whether or not payment is authorized, the on-line store will either accept the order and ship the product or reject the order.

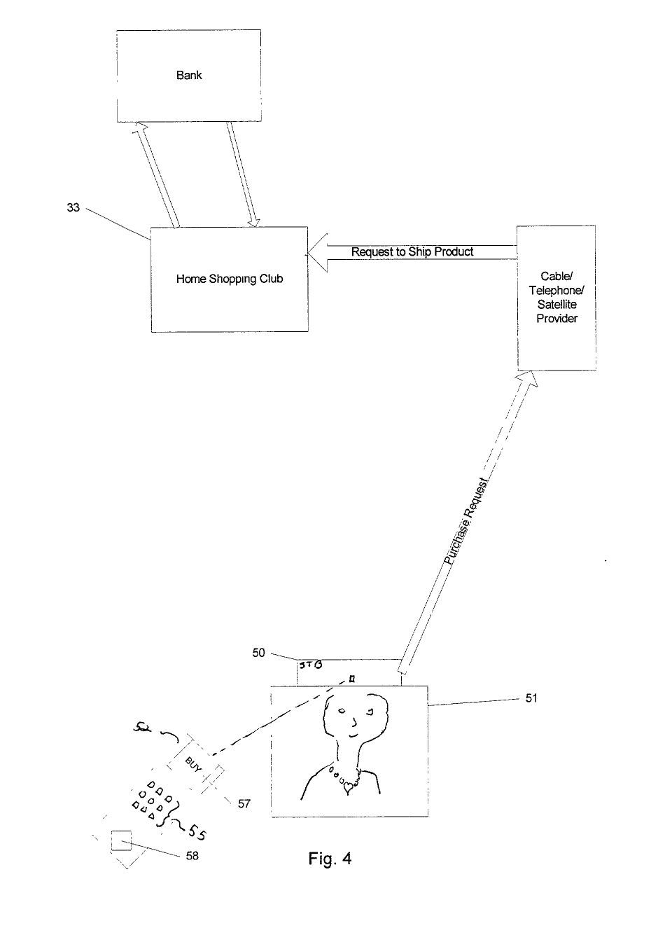

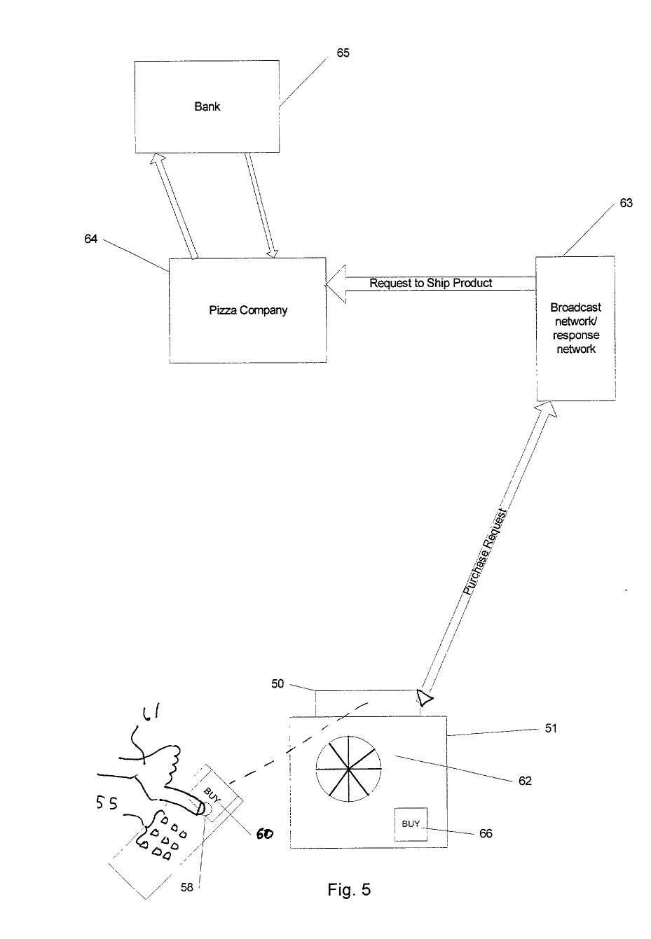

FIG. 4 shows another preferred embodiment of the instant invention where a home television system permits access to a single credit card account. In this case the key credit card information such as credit card number, expiration date and name on the account is stored locally in a set-top-box (“STB”) 50 by the credit card holder. Instead of the STB storing the key credit card information, a home PC, a TiVo personal television recorder or other local storage device stores the information. This local storage of the credit card information and access levels makes it easy for the credit card holder to change access levels and input different credit card/debit card key information.

In this embodiment the credit card holder, for example a parent, inputs the credit card information into the STB 50 or TV 51 or some other memory device associated with the television 51. In this case the remote control 52 contains keys 55 for data input to the STB 50. The STB 50 is connected via a two-way connection 56 to a television service or some other information source such as the Internet.

The credit card holder then also inputs into the STB 50 authorized user information. In this case let's assume the authorized users are a wife, a 16-year-old and a ten-year-old child. The credit card holder inputs sub-credit limits into the STB for each authorized user. In this preferred embodiment a fingerprint authentication button 58 is located on the remote control 52. The parent has the 10-year-old place his finger on the remote and inputs into the STB the sub-credit limit permitted to be spent, e.g. per month, by the 10-year-old. This sub-credit limit is then associated with the fingerprint information stored in the STB. The parent then tells the 16-year-old to do the same and assigns a second, perhaps different, sub-credit limit to the 16-year-old, and the wife does the same. The sub-credit limit should be less than or equal to the credit limit of the credit card whose key information is stored on the STB. Obviously, the fingerprint sensor is only one of the ways to authenticate an authorized user as other bioauthentication means can be used such as voice recognition, iris recognition, etc.

Operation of the device is as follows. Assume the 16-year-old boy sees a necklace on a home shopping network that he would like to purchase for his girlfriend. Giving the 16-year-old access to Dad's entire credit limit on the credit card could be problematic in such a situation. By authorizing sub-credit limits such as an amount equal to an allowance, the parent is assured that the 16-year-old will not exceed the allowance amount. The 16-year-old issues a “BUY” 57 request for the necklace. Either the STB 50 knows the purchase price from the video stream or the purchase price must be input via the remote control 52. The STB 50 requests authentication information from the person requesting the purchase, in this case the 16-year-old. The 16-year-old's finger is placed on the fingerprint sensor 58 and the fingerprint information is sent to the STB 50. The STB 50 compares this fingerprint information with the fingerprint information already stored in the STB 50. If it matches one of the stored fingerprints then a comparison is made between the product purchase price and the sub-credit limit allowed for the person having that fingerprint. If the product price is less than or equal to the sub-credit limit then the credit card key information is sent over the two-way connection to the home shopping club 53 to complete the order. The home shopping club then checks with the credit card company 59 to see if purchase is authorized for the credit card information it received, e.g. whether there is credit available.

By storing the credit card information and the different sub-credit limits locally, the credit card holder can easily change the sub-credit limits if, for example, it is the child's birthday, a special reward or the child is grocery shopping for the home.

In an alternative embodiment the child will have his own profile stored either locally or on a server which indicates the types of websites or services the child is permitted to order from e.g. only child friendly sites, or if it is a computer gaming site, how long the child may play and how much may be spent. This information is then accessed each time the child attempts to make a purchase or access a website. The bioauthentication information the child enters is compared to stored bioauthentication information to see if it matches bioauthentication information stored which has an associated profile which permits access to the website or credit card.

In another preferred embodiment the “BUY” button and fingerprint sensor are on a single key 60 so that depressing the “BUY” button automatically sends the authentication information to the STB and initiates the buying process as explained below with reference to FIG. 5 and ordering a pizza during the Super Bowl.

Scenario A: Authorized Consumer buys a pizza in his home using his client-based e wallet and authorization system.

Examples of the entities in this scenario are shown in FIG. 5:

user 61

TV screen with “BUY” button and other displayed info 62

Remote Control with “BUY” button 60

e-wallet residing on client, which is a TV or STB 50 in this case

response network 63

bank 64 to deliver final payment for purchase

merchant 64 [Pizza company]

The enhanced Ad 62 arrives for an impulse buy of a pizza. The mechanism through which this arrives can be following the DASE specification, using ATVEF, or other. This is the presentation of the offer of sale. As the pizza ad 62 is shown, in the lower right hand corner of the screen, for example, appears a “BUY” button 66. Also, on the consumer's remote control 52 is a matching “BUY” button 66 with a fingerprint sensor built in. This “BUY” button initiates both the identification, authentication of the user and the purchase itself.

The consumer 61 presses the “BUY” button 66. This initiates the “acceptance of the offer”, and sends a message to the client 50 (STE or TV) in a client-based situation.

Behind the scenes, on the back end, when the wallet software on the client 50 [TV, STB, etc.] receives the “acceptance of the offer” it checks to make sure that there is an e-wallet with funds available and authorization to shop. This can be a binary problem, yes or no, rather than a variable problem with dollar amounts attached. It is the e-wallet on the client 50 which automatically confirms the buyer's identity and authorization to shop without necessarily checking the amount of the purchase. This authorization is communicated to the response network 63.

Meanwhile, the response network 63, in response to the consumer's “acceptance of the offer” shows a new screen with pizza flavor options, such as mushroom, pepperoni, etc., and size options, such as medium and large and indicates pricing information at the same time. This new screen may have arrived at the same time that the enhanced ad arrived. It does not necessarily have to be a new packet of information but rather, the response network can unlock and deliver this info to the screen.

Using the remote control or voice or some other appropriate input mechanism, the consumer selects a pizza choice and gives the okay to purchase. For example, the consumer might choose the option “large vegetarian pizza for $15.” This selection triggers a check of the consumer's ability to pay [credit limit].

The check for ability to pay happens first at the client 50 to ensure designated spending privileges. This is a critical step in the process because there are so many possible sources of so-called funding for the purchase. In the case of a pizza, chances are that the funding is straight dollars and cents. The source of the funds in this case is the credit or debit card. The credit limit is the sub-credit limit set up for the purchaser. However, you can imagine a number of situations where the so-called funding might be virtual. For example, a gaming company might decide to award “Pizza Bucks” in co-promotions with the pizza company to their top networked game playing winners. In an open system, a child's fingerprint can identify him BOTH as a top game winner with $100 in Pizza Bucks as well as member of his household with a budget of $75 attached to the parent's credit card account. Another example of supplementing a spending account is where a child is given a base spending limit of $75, but he can raise that or lower that based on his behavior. So, if he watches educational programming, plays educational games, does research for school on the Internet, etc. he can earn rights to extra money in his account, that he can spend any way he wants. The final example is one where loyalty points are given, which can substitute for cash payments with the vendors whose goods and services are being purchased or used. This could be anything from “order 5 pizzas and the 6^{th} one is free,” to “you are a good customer, so the drinks are free this time,” to “since you bought 5 games last month, you have a virtual coupon for $25 off any further products.” This can be handled by the e-wallet in tandem with the response network, or a “cookie” can be stored on the STB 50 for a certain time limit. Now, with specific spending information at hand at the client 50, the e-wallet sends a message to the response network 63, to verify the consumer's ability to pay. This transaction mirrors the traditional mechanism employed by merchants who must confirm that a consumer's credit line is sufficient to make a purchase. This check is to determine that the credit card limit is sufficient. The previous check that took place was checking that the person doing the shopping [the child] had been authorized by the credit card holder [the parent] to make purchases in that shopping category and amount requested.

The response network can either initiate the authorization process or have the merchant initiate the authorization process. This includes checking the validity of credit card/debit card account, matching the delivery address to the billing address and any other security checks required by the internal processes of the transaction management companies. The bank 16 then gives the OK. This triggers 3 related actions.

The bank 65 pays the pizza company 64 and records the transaction, perhaps if the information is available as having been initiated by the child on the account.

The response network 63 sends the order for one large Vegetarian Pizza+delivery information to the pizza company 64.

The response network 63 can send a confirmation message to the screen indicating that 1 large Vegetarian Pizza is to be delivered to the specified address in 30 minutes.

At the end of the month, the bank statement arrives with purchase information, perhaps broken out by authorized user on the account. Under the child column the credit card owner sees the $15 pizza purchase. Alternatively, the set-top-box can store the purchases made locally so the parent can compare the purchases to his credit card statement to see who made what purchases.

Scenario 2. A child is vacationing in Florida with his parents at a hotel. The child sees the same pizza ad from scenario 1 but wants to order the pizza from his hotel room.

The goal of this scenario is to enable portability so that the child can access his wallet and spending privileges from anywhere he might be. The main difference between this scenario and the first scenario is that the wallet will be server-based, unless the wallet is replaced by a direct billing system at the hotel. In the case of a direct billing system at the hotel, the parents could pre-authorize $75 to be billed to room service, hotel TV video games, shopping, e commerce or whatever. If that happens, whenever a purchase is requested, the hotel server is responsible for checking to see that it is authorized.

The server-based wallet scenario assumes that the hotel does not provide any checking function or transaction management function. The only function offered in this instance is connectivity to the Internet. This scenario is the same as if the child was at a friend's house and wanted to make the pizza order.

If the fingerprint sensor-based authentication system is universal, everything is the same as in scenario 1 above, except that all of the actions which took place on the client above are now sent out to the server-based wallet. The child's fingerprint is read by the reader and the reader produces a code which points directly to the parent's wallet in the server database. The permission checking occurs there. Later on, the checking against the specific amount available occurs there again before going off to the bank to ensure credit limit/available funds.

While the invention has been described in connection with preferred embodiments, it will be understood that modifications thereof within the principles outlined above will be evident to those skilled in the art and thus, the invention is not limited to the preferred embodiments but is intended to encompass such modifications.

What is claimed is:

1. An account authorization system, comprising:
a memory which stores account information for an account holder and sub-credit limits and bioauthentication information for authorized users of the account;
a bioauthentication device for providing bioauthentication information to the memory;
a communication network; and
a processor, which compares received bioauthentication information to stored bioauthentication information and finds an associated sub-credit limit corresponding to the received bioauthentication information, to enable a purchase over the communication network.

2. An account authorization system as claimed in claim 1, wherein the memory is part of a consumer electronics device in the home.

3. An account authorization system as claimed in claim 2, wherein the bioauthentication device is a fingerprint sensor.

4. The account authorization system as claimed in claim 3, wherein the fingerprint sensor is located on a remote control.

5. A consumer electronics device, comprising
a memory which stores account information for an account holder and sub-credit limits and bioauthentication information for authorized users of the account;
a bioauthentication device which provides bioauthentication information to the memory;
a communication link; and
a processor, which compares received bioauthentication information to stored bioauthentication information to detect a match, and finds an associated sub-credit limit corresponding to the received bioauthentication information, to enable a purchase over the response network via the communication network up to a maximum of the sub-credit limit.

6. The consumer electronics device as claimed in claim 5, wherein the bioauthentication device is a fingerprint sensor.

7. The consumer electronics device as claimed in claim 6, wherein the fingerprint sensor is located on a remote control for the consumer electronics device.

8. The consumer electronics device as claimed in claim 5, wherein the bioauthentication device is a voice sensor.

9. The consumer electronics device as claimed in claim 5, for receiving an advertisement and for causing the advertisement to be displayed, and wherein upon receipt of an authorized user's bioauthentication information the processor initiates a buy command to the advertiser through the communication network.

10. The consumer electronics device as claimed in claims 5, 6 or 7 wherein the consumer electronics device is a set top box.

11. The consumer electronics device as claimed in claims 5, 6 or 7 wherein the consumer electronics device is a television.

12. A method of purchasing, comprising the steps of:
storing an account holder's credit card/debit card account information in a memory;
storing bioauthentication information of at least one authorized user of the owner's account;
assigning sub-credit limits to each authorized user;
receiving a response including bioauthentication information, which indicates a desire to make a transaction;
comparing the bioauthentication information response to the stored bioauthentication information to find a sub-credit limit which has corresponding matching bioauthentication information;
initiating the transaction if the matching bioauthentication information has a sub-credit limit sufficient to execute the transaction.

13. A device for locally controlling access to an account, comprising:
a local storage device for storing account information of an account holder and sub-credit limits and bioauthentication information for authorized users of the account;
a bioauthentication device for obtaining bioauthentication information from authorized users and an account holder;
a processor for changing sub-credit limits on the storage device in response to a request from the account holder, provided the account holder has provided bioauthentication information which matches bioauthentication information stored on the local storage device for the account holder, and
a communication network for authorizing a transaction on the account in response to a request from an authorized user or account holder provided that the bioauthentication information provided by the authorized user or account holder matches the bioauthentication information of the authorized user or account holder stored on the local storage device and that the transaction does not exceed the sub-credit limit storage on the local storage device of the authorized user or account holder making the request.

14. A consumer electronics device, comprising:
a memory which stores a profile of a user, the profile indicates access levels of the user, and sub credit limits of authorized users of an account;
a bioauthentication device which provides bioauthentication information to the memory;
a communication link, and
a processor, which compares received bioauthentication information to stored bioauthentication information to detect a match, and detects the access levels of the profile associated with the matching bioauthentication information to determine whether requested access over the communication link can be given based on the received bioauthentication information, and whether the subcredit limit associated with the received bioauthentication information is enough to complete a requested transaction.

15. The consumer electronics device as claimed is claim 14, wherein the memory also stores bioauthentication information of a profile maker, and wherein upon receipt of the profile maker's bioauthentication information the processor permits the profiles in the memory to be modified by the profile maker.

16. The consumer electronics device as claimed in claim 15, wherein the profile holds parental control information.

17. A device for locally controlling access to an account, comprising:
a local storage device for storing account information of an account holder bioauthentication information of authorized users of the account and profile information of the authorized users which indicates the types of goods and services the authorized users are permitted to purchase through the account;
a bioauthentication device for obtaining bioauthentication information from authorized users and an account holder; and
a processor for changing the profile information on the storage device in response to a request from the account holder.
